(19) United States
(12) Patent Application Publication
(10) Pub. No.: US 2025/0202075 A1
(43) Pub. Date: Jun. 19, 2025

(54) BATTERY COUPLING MECHANISM

(71) Applicant: GHP Group, Inc., Niles, IL (US)

(72) Inventors: Maocai HUANG, Niles, IL (US); Jingshou HE, Niles, IL (US)

(21) Appl. No.: 18/401,938

(22) Filed: Jan. 2, 2024

(30) Foreign Application Priority Data
Dec. 13, 2023 (CN) 2023234098159

(51) Int. Cl. H01M 50/534; H01M 50/548

(52) U.S. Cl. CPC H01M 50/534; H01M 50/548; H01M 2220/30

(57) ABSTRACT

Disclosed is technology that aims to solve the problem of requiring the purchase of different brands of batteries for a group of power tools. Specifically disclosed is a battery coupling mechanism that interfaces with different battery types to allow a user to use existing batteries rather than purchasing additional batteries for a power tool. For example, the technology can couple the battery to electrodes provided on a movable and elastically biased carrier while also providing structure for mechanically coupling the battery to the tool. By doing so, the coupling mechanism can mechanically and electrically couple different batteries to the same tool, relieving the requirement of purchasing a tool-specific battery.

### TECHNICAL FIELD OF THE INVENTION

The present technology relates to a battery coupling mechanism. In particular, the present technology relates to a mechanism for connecting different battery structures into the same battery-dependent device.

### BACKGROUND

Power tools are prevalent in modern society. Such tools can be used for outdoor landscaping, indoor construction, or virtually any other project that requires power. Many of these tools can be operated with gasoline or connected to a socket with an electrical cord. Still others can be operated by batteries to provide a cordless way for users to operate the tool.

Power tool manufacturers make a significant profit on the battery itself but a much lower profit on the tool. To incentivize battery purchases, different brands operate with batteries having brand-specific structures, requiring the user to purchase the battery associated with that brand for all power tools owned by the user. For example, a user who owns a drill from one brand is unlikely to buy a battery-powered edge trimmer of a different brand because doing so would require an additional battery purchase due to the different structure of the edge trimmer battery. The user is more likely to purchase the edge trimmer affiliated with the user's drill brand and use the same battery and charger for both tools.

### BRIEF DESCRIPTION OF THE SEVERAL VIEWS OF THE DRAWINGS

The present technology will be described with reference to the appended drawings. The drawings aid in the description of the present technology and are not to be considered to be limiting the scope of the appended claims. The accompanying drawings include:

FIG. 1 illustrates a bottom perspective view of a battery coupling mechanism according to at least some of the presently disclosed embodiments.

FIG. 2 illustrates a top perspective view of a battery coupling mechanism according to at least some of the presently disclosed embodiments.

FIG. 3 illustrates a perspective exploded view of a battery coupling mechanism according to at least some of the presently disclosed embodiments.

FIG. 4 illustrates another perspective exploded view of a battery coupling mechanism according to at least some of the presently disclosed embodiments.

FIGS. 5A and 5B illustrate rear perspective views of prior art batteries according to at least some of the presently disclosed embodiments.

FIGS. 6A and 6B illustrate front perspective views of the prior art batteries inserted into the battery coupling mechanism according to at least some of the presently disclosed embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present technology aims to solve the problem of requiring the purchase of different brands of batteries. The present technology includes a battery coupling mechanism that interfaces with different battery types to allow a user to use existing batteries rather than purchasing additional batteries for a power tool. For example, certain embodiments include an elastically biased carrier that can couple different brands of batteries to the same power tool based on the movability of the carrier. The carrier's electrodes can connect with those of a first battery when the carrier is in a first position, and connect with those of a second battery when the carrier is moved into a second position against the elastic bias of the carrier. By doing so, the coupling mechanism can mechanically and electrically couple different batteries to the same tool, relieving the requirement of purchasing a tool-specific battery.

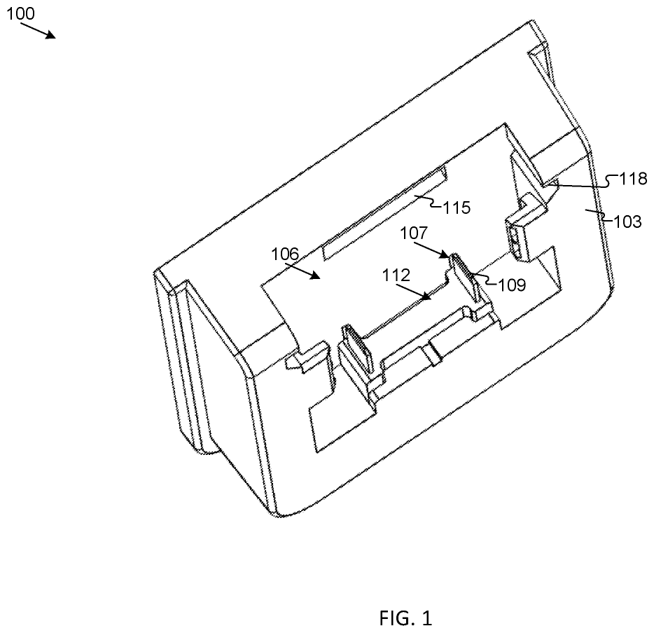

FIG. 1 illustrates a bottom perspective view of a battery coupling mechanism according to at least some of the presently disclosed embodiments. As shown, the battery coupling mechanism 100 includes a base 103 with an opening 106 that receives a battery when coupled to a power tool. An electrode 107 can include an exterior electrode 109 and be coupled to a carrier 112 that is movable against elastic bias, as disclosed below in more detail. A slot 115 can be defined within the base 103 to mechanically receive an elastically-biased protrusion from a battery that extends upward into the slot 115 for coupling the battery to the mechanism 100. Similarly, an indent 118 can be defined within the base 103 for engagement with elastically-biased structure from a battery, such as an elastically-biased tab that extends horizontally outwardly to engage with and mechanically couple the battery to the mechanism 100.

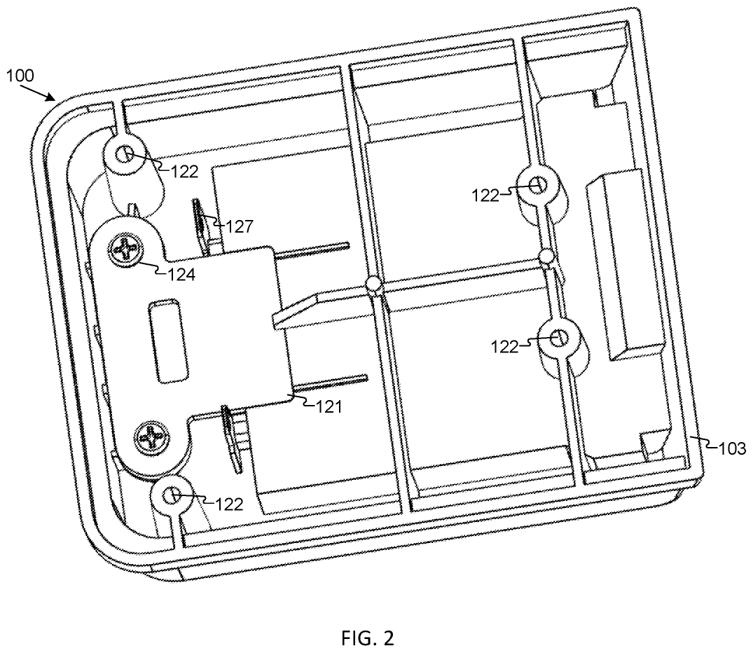

FIG. 2 illustrates a top perspective view of a battery coupling mechanism according to at least some of the presently disclosed embodiments. As shown, a bracket 121 can couple to the base 103 at apertures 122 and movably retain the carrier 112 in position. For example, the bracket 121 can be fixedly coupled to the base 103 by coupling fasteners 124 to the apertures 122. FIG. 2 further illustrates the interior electrode 127, which can be coupled to or integral with the exterior electrode 109 of the electrode 107.

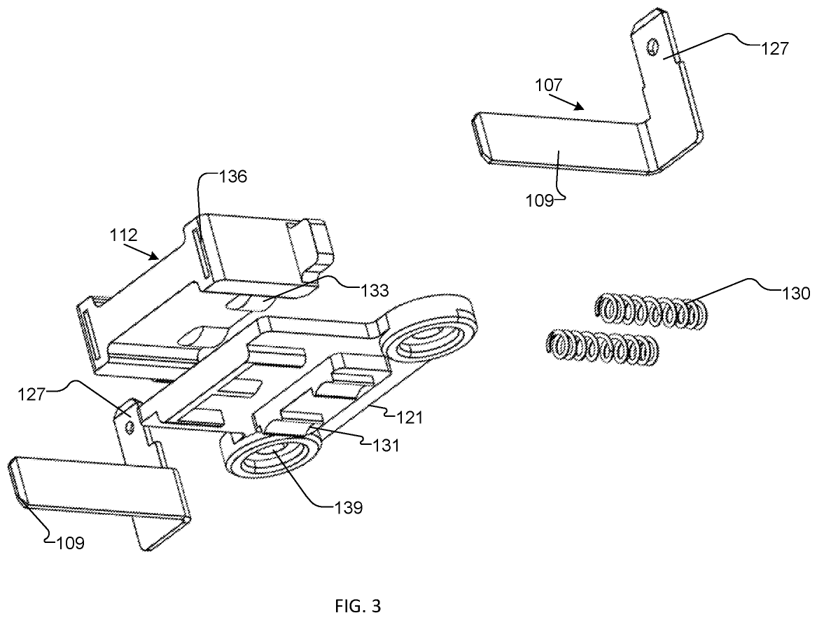

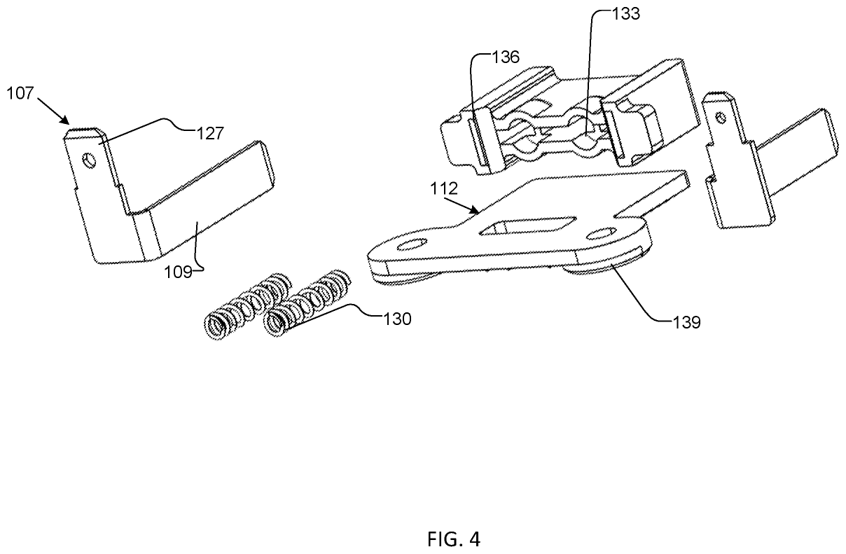

FIG. 3 illustrates a perspective exploded view of a battery coupling mechanism, and FIG. 4 illustrates another perspective exploded view of a battery coupling mechanism according to at least some of the presently disclosed embodiments. As shown, the carrier 112 is elastically biased by elastic members 130 that are disposed within an elastic member housing 133. For example, the bracket 121 can be placed above the carrier 112 and the elastic members 130 can be disposed in the elastic member housing 133 of the carrier 112. The elastic member housing 133 can then ride along the guides 131 of the bracket 121 for increased structural stability during use.

In some embodiments, the electrode 107 can include the interior electrode 127 extending upward for engagement with the electrodes of the power tool, and the exterior electrode 109 can extend horizontally for engagement with the electrodes of the battery. For example, as shown in FIGS. 1-4, the exterior electrode 109 (shown in FIG. 1) can extend through a channel 136 (shown in FIGS. 3 and 4) to provide both structural stability and also electrical insulation between the first and second ends of the electrode. A screw insert 139 can also be provided to allow coupling of the bracket 121 to the base 103.

The base 103 acts as the mechanical backbone of the mechanism 100 and defines negative space within it to engage with and mechanically couple to the batteries. For example, the indent 118 can be defined within the base 103 to mechanically couple to elastically-biased structure of a battery such as side-projecting protrusions of a first type of battery, while the slot 115 can be defined within the base to mechanically couple to elastically-biased structure of a battery such as upwardly-projecting protrusions of a second type of battery. The base 103 can also provide space for the carrier 112 to move within, under the elastic bias of the elastic members 130. In this manner, the battery can be mechanically coupled to the base via the slot 115 or the indent 118, and further can be electrically coupled to the electrode 107 for different batteries because the electrode 107 is carried on the elastically-biased carrier 112. That is, the carrier 112 can move under the elastic bias of the elastic members 130 to accommodate different structures of batteries that require the exterior electrodes 109 to be further within (pushed more against the elastic bias) or less within (pushed less against the elastic bias) the inside of the base 103.

The base 103 can also include various screw inserts 139, as discussed above with respect to FIG. 2. These screw inserts 139 can permit coupling of the bracket 121 to the base 103 via the fasteners 124. They can also permit the mechanism 100 itself to mechanically and electrically couple to a power tool through the apertures 122. That is, fasteners may insert through the apertures 122 and into corresponding screw inserts or apertures of the power tool for mechanically coupling to the power tool. In doing so, the interior electrodes 127 can electrically couple to an internal circuit of the power tool to selectively provide power to the power tool from the battery when a user engages, for example, a trigger or other selectivity mechanism.

As shown, the elastic members 130 can be springs. However, the elastic members 130 can be any structure that provides elastic bias, including but not limited to springs, such as coil springs, leaf springs, torsion springs, and compression springs. Additionally, other elastic members 130 may comprise elastomeric materials, polymers, or resilient structures that inherently possess elastic properties. These alternative elastic members 130 may include, for example, rubber bands, elastic cords, bungee elements, or any configuration of materials capable of exhibiting elastic deformation and generating a restorative force.

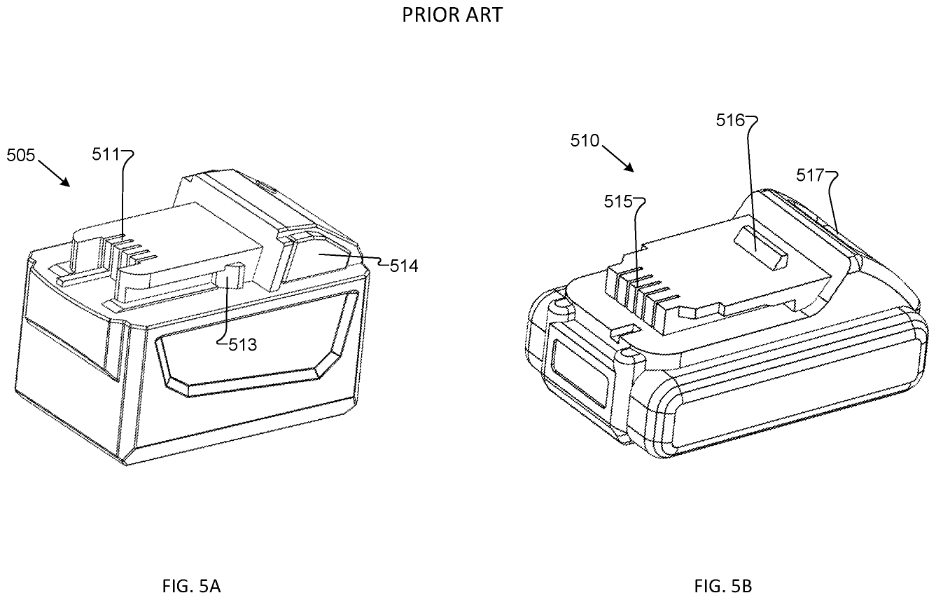

FIGS. 5A and 5B illustrate rear perspective views of prior art batteries according to at least some of the presently disclosed embodiments. As shown, a first battery 505 and a second battery 510 can both couple to the mechanism 100 despite both batteries 505, 510 having different mechanical coupling and electrical coupling structures. For example, the first battery 505 can include first battery electrodes 511 that couple with the exterior electrodes 109 of the mechanism 100 based on their spatial arrangement when mechanically coupled together. Similarly, the first battery 505 can include a tab 513 that can mechanically couple to the indent 118 of the mechanism 100 for releasable engagement. As one example, the tabs 513 can be elastically biased in an engaging position and can be released from that elastic bias by pushing a side button 514 inward, as is well known in the art.

The second battery 510 includes a second battery electrode 515 that couples to the exterior electrodes 109 of the mechanism 100, similar to the first battery 105. The second battery 510 can mechanically couple to the mechanism 100 via an elastically biased protrusion 516 engaging in an upward direction against the slot 115. A front button 517 can release the elastic engagement and allow removal of the second battery 510, as is well known in the art.

The first battery 505 and second battery 510 can couple to the mechanism 100 and, as a result, the power tool, as described below. It is helpful to note that the coupling of the batteries 505, 510 to the mechanism 100 includes both a mechanical and electrical coupling. Each of these will be discussed in turn.

To mechanically couple to the mechanism 100, the first battery 505 includes a tab 513 that can mechanically couple to the indent 118 of the mechanism 100. In some embodiments, the first battery 505 includes two tabs 513—one on each horizontal side of the first battery 505, and each of the tabs 513 couple to the mechanism 100 in the manner described above. The tabs 513 are elastically biased outward by a spring or other bias member, but can be pushed inward by the side button 514 for releasable engagement with the mechanism. Similarly, the second battery 510 can include a protrusion 516 that is elastically biased in an upward direction and that can engage with the slot 115 for releasable engagement. To release the engagement and remove the second battery 510, a user can push on the front button 517, which is connected to the protrusion 516 so as to push it inward when the front button 517 is pushed inward.

To electrically couple the first battery 505 to the mechanism 100, the mechanical coupling will position the first battery electrodes 511 against the exterior electrodes 109 of the mechanism 100. Similarly, when mechanically coupled to the mechanism 100, the second battery 510 will position its second battery electrodes 515 against the exterior electrodes 109 of the mechanism. One difference in the electrical coupling of the two batteries 505, 510 is that the first battery 505 couples to the mechanism 100 with less force applied against the elastically-biased carrier 112, whereas the second battery 510 couples to the mechanism 100 with more bias applied by the carrier 112. This is due to the spatial arrangement of the respective battery electrodes 511, 515.

Note in FIGS. 5A and 5B that there is more space between the first battery electrodes 511 and the left-hand side of the first battery 505 (as shown in FIG. 5A) as compared to the space between the second battery electrodes 515 and the left-hand side of the second battery 510 (as shown in FIG. 5B). This means it would be difficult to couple both of the batteries 505, 510 to a mechanism 100 with a rigidly-located exterior electrode 109 due to the differing spatial arrangements of the battery electrodes 511, 515. However, the elastic bias of the carrier 112 allows the exterior electrodes 109 to be pushed inward when a battery has electrodes located closer to the left-most edge (as shown in FIG. 5B). In the example provided, the second battery 510 would push against the elastic bias of the carrier 112 when mechanically coupled to the mechanism 100 as described above. In doing so, the second battery 510 will electrically couple to the exterior electrodes 109 of the carrier 112 despite having different mechanical dimensions as the first battery 505, aided in part by the movable and elastically-biased carrier 112 that includes the exterior electrodes 109. Accordingly, the carrier 112 can accommodate multiple different battery dimensionalities by providing a movable and elastically-biased carrier 112 with exterior electrodes 109 that can be pushed inward to accommodate the different battery dimensions. Users of the mechanism 100 and batteries 505, 510 can therefore use one battery for other power tools (e.g., a drill) and, assuming the electrical specifications are the same, can use the same battery for the tool associated with the mechanism 100 even if the tool is for a different brand than the drill.

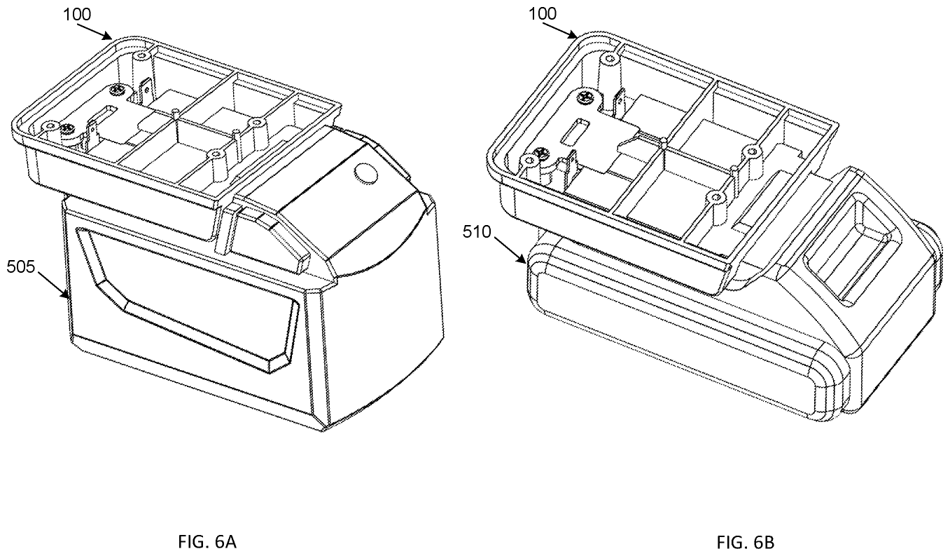

FIGS. 6A and 6B illustrate front perspective views of the prior art batteries inserted into the battery coupling mechanism according to at least some of the presently disclosed embodiments. As shown, the first battery 505 can couple to the mechanism 100 as described above. Similarly, the second battery 510 can also couple to the mechanism 100 as described above. In doing so, a user can use an existing battery for the tool associated with the mechanism even if the tool is not the same brand as the battery.

Benefits, other advantages, and solutions to problems have been described herein with regard to specific embodiments. However, the benefits, advantages, solutions to problems, and elements that may cause any benefit, advantage, or solution to occur or become more pronounced are not to be construed as critical, required, or essential features or elements of the disclosure.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

Further, it should be appreciated that in the appended claims, reference to an element in the singular is not intended to mean “one and only one” unless explicitly so stated, but rather “one or more.”

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

The words “illustrative” or “exemplary” are used herein to mean “serving as an example, instance, or illustration.” Any aspect described herein as “illustrative” or “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Aspect 1. A mechanism for coupling a battery to a power tool, the mechanism comprising: a base; a carrier elastically-biased in a first direction and movable within the base; an exterior electrode provided on the carrier and extending in the first direction; and at least one of a slot and an indent defined within the base and structured to receive elastically-biased structure from a battery, wherein the elastic bias of the carrier is structured to position the exterior electrode in at least a first position to receive a first battery, and a second position to receive a second battery.

Aspect 2. The mechanism of Aspect 1, wherein the carrier includes an elastic member housing that receives an elastic member that provides the elastic bias of the carrier.

Aspect 3. The mechanism of any of Aspects 1 to 2, further comprising a bracket coupled to the base and having a guide, and wherein the elastic member housing is structured to ride along the guide when moved in either the first direction or a second direction opposite the first direction.

Aspect 4. The mechanism of any of Aspects 1 to 3, wherein the slot is structured to receive an elastically-biased protrusion, and the indent is structured to receive an elastically-biased tab.

Aspect 5. The mechanism of any of Aspects 1 to 4, further comprising an interior electrode coupled to the exterior electrode and configured to electrically couple to a power tool to provide power to the power tool via the battery.

Aspect 6. The mechanism of any of Aspects 1 to 5, further comprising a bracket coupled to the base and movably retaining the carrier.

Aspect 7. The mechanism of any of Aspects 1 to 6, wherein the carrier includes a channel and wherein the exterior electrode extends through the channel.

Aspect 8. A power tool comprising: a battery; and a mechanism for coupling the battery to the power tool, the mechanism comprising: a base; a carrier elastically-biased in a first direction and movable within the base; an exterior electrode provided on the carrier and extending in the first direction; and at least one of a slot and an indent defined within the base and structured to receive elastically-biased structure from a battery, wherein the elastic bias of the carrier is structured to position the exterior electrode in at least a first position to receive a first battery, and a second position to receive a second battery.

Aspect 9. The power tool of Aspect 8, wherein the carrier includes an elastic member housing that receives an elastic member that provides the elastic bias of the carrier.

Aspect 10. The power tool of any of Aspects 8 to 9, further comprising a bracket coupled to the base and having a guide, and wherein the elastic member housing is structured to ride along the guide when moved in either the first direction or a second direction opposite the first direction.

Aspect 11. The power tool of any of Aspects 8 to 10, wherein the slot is structured to receive an elastically-biased protrusion, and the indent is structured to receive an elastically-biased tab.

Aspect 12. The power tool of any of Aspects 8 to 11, further comprising an interior electrode coupled to the exterior electrode and configured to electrically couple to a power tool to provide power to the power tool via the battery.

Aspect 13. The power tool of any of Aspects 8 to 12, further comprising a bracket coupled to the base and movably retaining the carrier.

Aspect 14. The power tool of any of Aspects 8 to 13, wherein the carrier includes a channel and wherein the exterior electrode extends through the channel.

Aspect 15. A method of coupling a first battery and a second battery to a power tool comprising: inserting the first battery into a mechanism, the mechanism having an elastically-biased carrier with an exterior electrode extending therefrom; mechanically coupling the first battery to the mechanism by coupling elastically-biased structure of the first battery to at least one of a slot and an indent defined within the mechanism, wherein the mechanical coupling includes inserting the first battery into the mechanism against the elastic bias of the carrier; removing the first battery; inserting a second battery into the mechanism by inserting the second battery farther against the elastic bias of the carrier as compared to the first battery.

Aspect 16. The method of Aspect 15, wherein the carrier includes an elastic member disposed within an elastic member housing.

Aspect 17. The method of any of Aspects 15 to 16, wherein the mechanism further includes a bracket having a guide, and wherein the elastic member housing rides along the guide when moved in a first direction and a second direction opposite the first direction.

Aspect 18. The method of any of Aspects 15 to 17, wherein mechanical coupling includes the slot receiving an elastically-biased protrusion, and/or the indent receiving an elastically-biased tab.

Aspect 19. The method of any of Aspects 15 to 18, wherein the mechanism further includes a bracket movably retaining the carrier.

Aspect 20. The method of any of Aspects 15 to 19, wherein the carrier includes a channel and wherein an electrode of the mechanism extends through the channel.

What is claimed is:

1. A mechanism for coupling a battery to a power tool, the mechanism comprising:
a base;
a carrier elastically-biased in a first direction and movable within the base;
an exterior electrode provided on the carrier and extending in the first direction; and
at least one of a slot and an indent defined within the base and structured to receive elastically-biased structure from a battery,
wherein the elastic bias of the carrier is structured to position the exterior electrode in at least a first position to receive a first battery, and a second position to receive a second battery.

2. The mechanism of claim 1, wherein the carrier includes an elastic member housing that receives an elastic member that provides the elastic bias of the carrier.

3. The mechanism of claim 2, further comprising a bracket coupled to the base and having a guide, and wherein the elastic member housing is structured to ride along the guide when moved in either the first direction or a second direction opposite the first direction.

4. The mechanism of claim 1, wherein the slot is structured to receive an elastically-biased protrusion, and the indent is structured to receive an elastically-biased tab.

5. The mechanism of claim 1, further comprising an interior electrode coupled to the exterior electrode and configured to electrically couple to a power tool to provide power to the power tool via the battery.

6. The mechanism of claim 1, further comprising a bracket coupled to the base and movably retaining the carrier.

7. The mechanism of claim 1, wherein the carrier includes a channel and wherein the exterior electrode extends through the channel.

8. A power tool comprising:
a battery; and
a mechanism for coupling the battery to the power tool, the mechanism comprising:
a base;
a carrier elastically-biased in a first direction and movable within the base;
an exterior electrode provided on the carrier and extending in the first direction; and
at least one of a slot and an indent defined within the base and structured to receive elastically-biased structure from a battery,
wherein the elastic bias of the carrier is structured to position the exterior electrode in at least a first position to receive a first battery, and a second position to receive a second battery.

9. The power tool of claim 8, wherein the carrier includes an elastic member housing that receives an elastic member that provides the elastic bias of the carrier.

10. The power tool of claim 9, further comprising a bracket coupled to the base and having a guide, and wherein the elastic member housing is structured to ride along the guide when moved in either the first direction or a second direction opposite the first direction.

11. The power tool of claim 8, wherein the slot is structured to receive an elastically-biased protrusion, and the indent is structured to receive an elastically-biased tab.

12. The power tool of claim 8, further comprising an interior electrode coupled to the exterior electrode and configured to electrically couple to a power tool to provide power to the power tool via the battery.

13. The power tool of claim 8, further comprising a bracket coupled to the base and movably retaining the carrier.

14. The power tool of claim 8, wherein the carrier includes a channel and wherein the exterior electrode extends through the channel.

15. A method of coupling a first battery and a second battery to a power tool comprising:
inserting the first battery into a mechanism, the mechanism having an elastically-biased carrier with an exterior electrode extending therefrom;
mechanically coupling the first battery to the mechanism by coupling elastically-biased structure of the first battery to at least one of a slot and an indent defined within the mechanism, wherein the mechanical coupling includes inserting the first battery into the mechanism against the elastic bias of the carrier;
removing the first battery;
inserting a second battery into the mechanism by inserting the second battery farther against the elastic bias of the carrier as compared to the first battery.

16. The method of claim 15, wherein the carrier includes an elastic member disposed within an elastic member housing.

17. The method of claim 16, wherein the mechanism further includes a bracket having a guide, and wherein the elastic member housing rides along the guide when moved in a first direction and a second direction opposite the first direction.

18. The method of claim 15, wherein mechanical coupling includes the slot receiving an elastically-biased protrusion, and/or the indent receiving an elastically-biased tab.

19. The method of claim 15, wherein the mechanism further includes a bracket movably retaining the carrier.

20. The method of claim 15, wherein the carrier includes a channel and wherein an electrode of the mechanism extends through the channel.
